(19) United States
(12) Patent Application Publication
(10) Pub. No.: US 2013/0216986 A1
(43) Pub. Date: Aug. 22, 2013

(54) COGNITIVE APTITUDE ASSESSMENT TOOL

(71) Applicant: ATHLETIC INTELLIGENCE MEASURES, LLC, (US)

(72) Inventors: Scott Goldman, Tucson, AZ (US); James Bowman, Tucson, AZ (US)

(73) Assignee: ATHLETIC INTELLIGENCE MEASURES, LLC, Tucson, AZ (US)

(21) Appl. No.: 13/767,770

(22) Filed: Feb. 14, 2013

Related U.S. Application Data
(60) Provisional application No. 61/600,864, filed on Feb. 20, 2012.

(51) Int. Cl. G09B 19/00

(52) U.S. Cl. CPC G09B 19/00
USPC 434/236

(57) ABSTRACT

Applicants' innate cognitive aptitude assessment tool is implemented on one or more computing devices within a system, to determine one or more innate cognitive aptitudes of a participant. The participant takes an exam including questions that are geared towards assessing one or more innate cognitive aptitudes by requesting a response to one or more images. The responses of the participant are evaluated and an innate cognitive aptitude profile of the participant is created. The profile of the participant is compared to one or more known cognitive aptitude profiles and a category of the participant's cognitive aptitude is, in turn, determined.

### CROSS-REFERENCE TO RELATED APPLICATIONS

This application claims priority to, and the benefit of, U.S. Patent Application Ser. No. 60/600,864, entitled “Cognitive Aptitude Assessment Tool,” filed Feb. 20, 2012, the entire contents of which are incorporated herein by reference.

### FIELD

Embodiments generally relate to an assessment tool and more particularly to products, articles of manufacture, methods, devices, and systems for assessing an innate cognitive aptitude of a participant based on responses of the participant to a series of tests in an exam.

### BACKGROUND

It is often believed that the best athletes are those that are most physically fit. Built upon this premise, coaches, general managers, scouts, and agents often assess a player's potential for success based on superior measured physical attributes such as size, speed, agility, and strength of the player during a physical activity. However, success depends on more than just the physical prowess of the player. Rather, a player's innate cognitive aptitudes to implement a game plan and process in game information impact the player's performance during a game or meet.

Accordingly, it would be an advance in the art to provide solutions that can help facilitate assessment of a player's innate cognitive aptitudes.

### SUMMARY

In certain embodiments, a cognitive aptitude of a participant is assessed. An exam is administered to the participant including rendering, on a display, a timed succession of questions about one or more images and corresponding potential replies. The potential replies are independent of a reading comprehension and writing ability of the participant. The responses of the participant, selected from the potential replies, are received. The responses are compared to a set of predetermined responses that are indicative of a known cognitive aptitude to find a result. A category of a cognitive aptitude of the participant is determined based on the result. The category is, in turn, reported.

In certain embodiments, responses of a participant to an exam including one or more questions about respective images are received. Each of the questions has a limited reply time and the responses are independent of a past learned knowledge of the participant. The responses are compared to a set of predetermined responses that are indicative of a known cognitive aptitude to find a result. A category of a cognitive aptitude of the participant is determined based on the result. The category is reported.

### COPYRIGHT

Contained herein are materials subject to copyright protection. The copyright owner has no objection to the facsimile reproduction of the patent disclosure by any person as it appears in the Patent and Trademark Office patent files or records, but otherwise reserves all rights to the copyright whatsoever.

### BRIEF DESCRIPTION OF THE DRAWINGS

The invention will be better understood from a reading of the following detailed description taken in conjunction with the drawings in which like reference designators are used to designate like elements, and in which:

FIG. 1 is a schematic of an exemplary implementation of Applicants' cognitive assessment tool;

FIG. 2 is a schematic showing an exemplary question and corresponding potential replies for Applicants' cognitive assessment tool;

FIG. 3A is a screen shot of a user interface rendered on a computing device;

FIG. 3B is a screen shot of a user interface rendered on a computing device;

FIG. 3C is a screen shot of a user interface rendered on a computing device;

FIG. 4 depicts a block diagram illustrating an exemplary system in which an innate cognitive aptitude of a participant is assessed;

FIG. 5 illustrates a flow chart of an exemplary method for assessing an innate cognitive aptitude of a participant;

FIG. 6 is a screen shot of a user interface rendered on a computing device;

FIG. 7 is a screen shot of a user interface rendered on a computing device;

FIG. 8A illustrates a portion of a report about one or more innate cognitive aptitudes of a participant;

FIG. 8B illustrates a portion of a report about one or more innate cognitive aptitudes of a participant;

FIG. 9A illustrates a portion of a report about one or more innate cognitive aptitudes of a participant; and

FIG. 9B illustrates a portion of a report about one or more innate cognitive aptitudes of a participant.

### DETAILED DESCRIPTION

The invention is described in preferred embodiments in the following description with reference to the FIGs., in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” “in certain embodiments,” and similar language throughout this specification may, but do not necessarily, all refer to the same embodiment. It is noted that, as used in this description, the singular forms “a,” “an” and “the” include plural referents unless the context clearly dictates otherwise.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

A person's performance in a task is shaped by his or her cognitive abilities and skills. For example, a person's performance in a traditional occupation is shaped by human cognitive abilities that are classified into one or more categories such as:
Crystallized Intelligence, which measures the breadth and depth of a person's acquired knowledge, the ability to reason using previously learned experiences or procedures, and the ability to communicate one's knowledge;
Fluid Intelligence, which includes the broad ability to reason, form concepts, and solve problems using novel procedures or unfamiliar information;
Reading & Writing Ability, which includes basic reading and writing skills;
Quantitative Reasoning, which includes the ability to comprehend quantitative concepts and relationships;
Long-Term Storage and Retrieval, which includes the ability to store information and retrieve it later in the process of thinking;
Short-Term Memory, which includes the ability to apprehend and hold information in immediate memory and then use it within a few seconds;
Visual Processing, which includes the ability to perceive, synthesize, analyze, and think with visual patterns, including the ability to store and recall visual representations;
Auditory Processing, which includes the ability to analyze, synthesize, and distinguish auditory stimuli;
Processing Speed, which includes the ability to perform automatic cognitive tasks, specially when measured under pressure to maintain focused attention (e.g., measured in minutes); or
Reaction Time, which includes the ability to immediacy react to stimuli or a task (e.g., typically measured in seconds or fractions of seconds).

However, the cognitive abilities relevant to performance during physical activities differ from those in traditional occupations, e.g., for example, while traditional occupations may rely heavily on a person's verbal skills, syllogistic reasoning, or prior learned knowledge, such as reading comprehension and writing ability, athletic performance is a function of a participant's cognitive aptitudes. Examples of cognitive aptitudes include reaction time, visual processing, processing speed, and long-term storage and retrieval.

Innate cognitive aptitudes of a participant (e.g., a player, a fireman, a soldier, an employee, or a potential employee) relate to the participant's inherent mental abilities that impact physical performance. To illustrate, a player of American football, learns a complex playbooks (e.g., visual processing) and repeatedly adjust his play (e.g., memory retrieval) during (e.g., reaction time) the course of a single game. Here, the player's reading and writing skills, deductive reasoning, or ability to verbally communicate acquired knowledge are irrelevant to the performance of the player on the field. Moreover, the cognitive abilities coveted for performance need not be homogenous across positions within a sport. For example, a quarterback absorbs an offensive playbook and recalls assignments of other positions and routes during execution of a game. Here, the quarterback of a team relies more heavily on visual processing and memory recall, than, for example, the running back of the team that perhaps relies more on reaction time. Like body morphology, these cognitive abilities are innate, independent of past knowledge of the player.

Applicants' innate cognitive aptitude assessment tool is used to assess one or more innate cognitive aptitudes of a participant, such as a player of a sport, or fireman, or a soldier. Decision makers impacting a career path or training of the participant in turn, use the assessment of the innate cognitive aptitude. For example, coaches, recruiters, scouts, sport team managers, or team representatives, use the assessment of the innate cognitive aptitudes of a participant, optionally along with other measurement tools, to determine recruitment, career path, and/or training of the player. Examples of other measurement tools include (1) measuring the player's physical skills, such as by determining how fast the player is able to run in a 40 meter dash; (2) a personality test that determines an emotional stability of the player; and (3) a coping test that determines a level of determination or drive of the player.

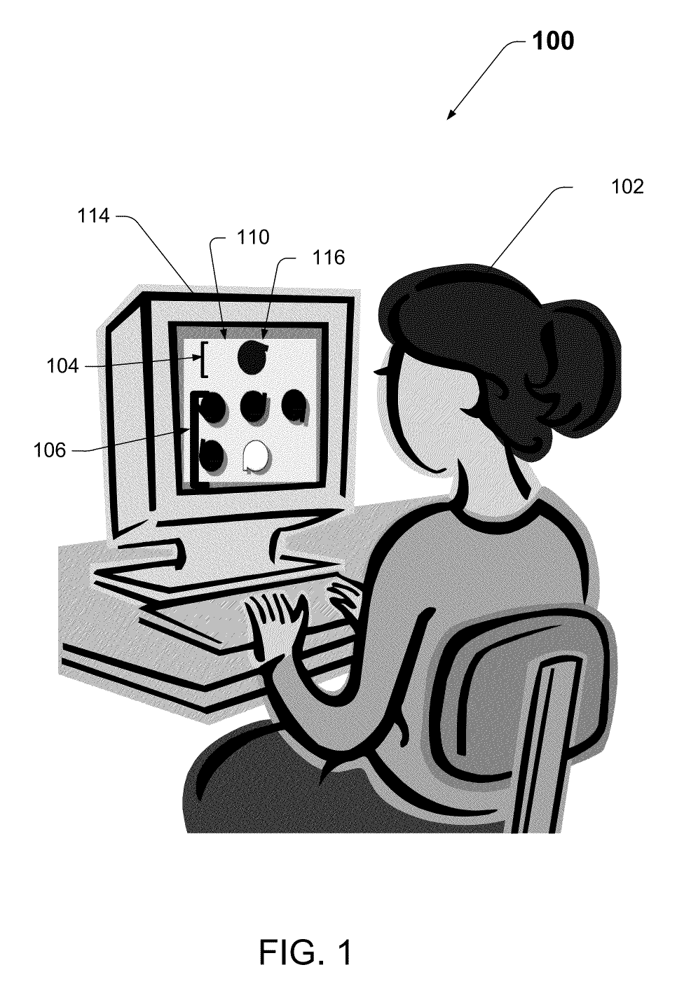

Referring to FIG. 1, a schematic 100 illustrates an exemplary implementation of Applicants' cognitive assessment tool. A participant 102 takes an exam 110 rendered on a computing device 114. The exam 110 includes one or more questions that each correspond to one or more innate cognitive aptitudes, such as reaction time, visual processing, processing speed, and long-term storage and retrieval; other cognitive abilities and combinations thereof are also contemplated. The potential replies to the respective questions are independent of a past knowledge of the participant 102, such that the past knowledge of the participant 102 does not impact the exam 110. For example, the exam 110 does not test a reading or writing comprehension of the participant 102. In certain embodiments, the computing device 114 executes a program to read the questions and/or instructions to the participant 102. The responses of the participant 102 are evaluated to determine an overall profile of the innate cognitive aptitudes of the participant 102. The profile of the participant 102 is compared to one or more known cognitive aptitude profiles. A category of the participant's 102 innate cognitive aptitude is, in turn, determined and reported.

The exam 110 of FIG. 1 includes an exemplary question 104 and corresponding potential replies 106. Other questions and corresponding potential replies are also contemplated. In FIG. 1, exemplary question 104 includes an image 116. Although a single image 116 is illustrated in FIG. 1 for exemplary question 104, any number of images is possible, such as a portion of an image or a plurality of images. Moreover, the exemplary question 104 includes an image that has a circular shape. Other images are also contemplated. Examples of images include: shapes, pictures, photographs, maps, drawings, words, numbers, alphanumerics, emoticons, and a combination thereof. In certain embodiments, the image is selected from the group consisting of a two-dimensional image and three-dimensional image.

Examples of potential replies 106 are replies that each include a second image that is selected from the group consisting of: the image in the question (“first image”); a rotation of the first image; a mirror reflection of the first image; a change in contrast of the first image; a shadow of the first image; a warped first image; an augmented first image; a diminished first image; and a combination thereof.

The corresponding potential replies 106 are each independent of a past knowledge of the participant 102. For example, in certain embodiments, the exemplary question 104 of the exam 110 instructs the participant 102 to select from among the respective potential replies 106 that shows the image 116 in a rotated orientation. Here, the potential replies are independent of a reading or writing ability of the participant 102. Moreover, the potential replies 106 are independent of the Crystallized Intelligence, the Fluid Intelligence and Auditory Processing of the participant 102 because the participant 102 does not rely on an ability to reason using previously learned experiences, an ability to solve problems using novel procedures, or an ability to analyze auditory stimuli, for example.

In certain embodiments, the exam 110 has several sections, each of which has questions measuring a corresponding innate cognitive aptitude. To illustrate, in certain embodiments, the exam 110 has four sections: a first section including questions that measure Visual Processing; a second section including questions that measure Reaction Rime; a third section including questions that measure a Processing Speed; and a fourth section that includes questions that measure a Long-Term Storage and Retrieval of the participant 102.

In certain embodiments, each section has a set of questions that are targeted to test the corresponding innate cognitive aptitude of the respective section. For example, the first section includes a set of questions that ask the participant 102 to: rotate a shape, match a design, find a route, memorize a map, or memorize a shape. Here, the participant 102 is tested in her ability to perceive, analyze, synthesize, and think with visual patterns, including the ability to store and recall visual images. The second section includes a set of questions that ask the participant 102 to: react to a visual stimulus, choose from among target and distracter stimuli, and inspect images to select a predefined quality of the image. Here, the participant 102 is tested in her ability to react to stimuli or a task. The third section includes a set of questions that ask the participant 102 to: match an picture/number pair with another picture/number pair, and match a word/number pair with another word/number pair. Here, the participant 102 is tested in her ability to perform automatic cognitive tasks. The fourth section includes a set of questions that ask the participant 102 to: match a first number with another number. Here, the participant 102 is tested in her ability to store information and fluently retrieve it later in the process of thinking The table below includes exemplary implementations of the sets of questions just described, wherein the sited time durations and length measurements are approximates provided for illustrative purposes:

TABLE 1

| Section | Set # | Set Questions | Program Requirements |
|---|---|---|---|
| 1 | 1 | Shape Rotations | Practice: shapes displayed on the screen and then rotated to |
| | | | see how they would look when turned. Corrective feedback |
| | | | given for practice items. Test: when the participant 102 |
| | | | responds, the program records whether he selected 1 or 2, to |
| | | | indicate that the shape he are looking at was the same or not. |
| | | | The participant 102 can work as quickly or slowly as he need |
| | | | to, but time should be stopped at the end of 3 minutes. If he |
| | | | finishes sooner, he indicates that he has finished. Optionally |
| | | | record the number correct and incorrect, in addition to the |
| | | | amount of time (e.g., if less than 3 min). |
| 1 | 2 | Block Rotations | Practice: like Subtest 1, rotate pictures, but this time 3D |
| | | | representations of images such as blocks with designs on each |
| | | | side. Participant's 102 responses are recorded (1 or 2) if |
| | | | blocks are the same or different. Corrective feedback on |
| | | | practice items. Test: 3-minute time limit, but he can indicate if |
| | | | they finish sooner. Record number correct, incorrect, and |
| | | | time (e.g., if less than 3 min). |
| 1 | 3 | Design Matching | Practice: Participant 102 s taps boxes to change them so |
| | | | that they look like a design simultaneously and/or |
| | | | previously shown. Participant's 102 responses are |
| | | | recorded as the same or different from the designs shown. |
| | | | Corrective feedback on practice items. Test: 3-minute |
| | | | time limit, but they can indicate if he finishes sooner. |
| | | | Record number of boxes correct, incorrect, and time in |
| | | | providing the response (e.g., if less than 3 min). |
| 1 | 4 | Route Finding | Demonstration of shortest route from one point to |
| | | | another, using images. Rules explained. Practice: small |
| | | | 3D grid presented with numbers and letters and/or |
| | | | images. For example a 2-D checkerboard is presented |
| | | | with each box representing a move. Participant 102 |
| | | | indicates the fewest number of moves needed to arrive at |
| | | | the destination. Corrective feedback given for incorrect |
| | | | responses. 30 seconds for practice; otherwise, answers |
| | | | provided. Test: full grid presented. Answers entered the |
| | | | same way. Time limit is 3 minutes, unless the participant |
| | | | 102 finishes sooner. Record number correct, incorrect, |
| | | | and time (e.g., if less than 3 min). |
| 1 | 5 | Memory for | Practice: screen will display one or more maps for 30 |
| | | Maps | seconds, which are then removed from the display. |
| | | | Subsequently a set of maps is displayed on the screen. |
| | | | Participant 102 will indicate whether one or more of the |
| | | | maps in the set of maps are the same or different from |
| | | | ones he saw previously. Corrective feedback on practice |
| | | | items. Test: the initial one or more maps will be |
| | | | presented for 3 seconds and then they are shown |
| | | | additional maps. Record number correct and incorrect. |
| 1 | 6 | Memory for | Practice: screen displays various shapes in a |
| | | Shapes | predetermined pattern for 1 minute. The participant 102 |
| | | | is instructed to study the images until time expires and try |
| | | | to remember the size, position, and spacing of the |
| | | | images. The participant 102 is then presented smaller |
| | | | boxes with some of the shapes just seen previously in |
| | | | them. Participant 102 will indicate whether he has seen |
| | | | the shapes or not. Corrective feedback on practice items. |
| | | | Test: another rendition of images (boxes and shapes) is |
| | | | presented for 3 minutes (for studying) and then boxes |
| | | | with shapes will be presented for an additional 2 minutes. |
| | | | Record number correct, incorrect, and time (e.g., if less |
| | | | than 2 min). |
| 2 | 1 | Simple Reaction | Practice: A 2-D or 3-D shape (e.g., square) is flashed in |
| | | Time | the middle of the screen until the space bar or the screen |
| | | | is pressed or 2,000 ms passes (whichever is first). Test: |
| | | | the interval between presentations of the shape will be |
| | | | varied between 500 and 2,000 ms. Reaction time in |
| | | | milliseconds and accuracy (omissions and commissions) |
| | | | will be recorded. |
| 2 | 2 | Choice Reaction | Practice: present visual targets to participant 102 s for |
| | | Time | brief periods of time (i.e., between 500 and 1,000 ms). |
| | | | There are two target stimuli and three distracter stimuli. |
| | | | The participant 102 must press the response key as |
| | | | quickly as possible when presented with one of the two |
| | | | target stimuli but must refrain from pressing the key |
| | | | when any of the three distracters are presented. If the |
| | | | response key is pressed, the image is removed. If the key |
| | | | is not pressed, the image disappears after 1,000 ms. |
| | | | Participant 102 s are presented with a total of 50 trials, for |
| | | | example. The subtest score is based on both speed and |
| | | | accuracy, omissions, and commissions. |
| 2 | 3 | Inspection Time | Practice: participant 102 is presented with a “+” shaped |
| | | | cue 4 mm by 4 mm for 500 ms before seeing an inverted |
| | | | U-shape with legs of different lengths for a very brief |
| | | | period (i.e., ranging from 6 ms to 200 ms), and he decides |
| | | | which of the two legs was longest. The long leg is |
| | | | 50 mm, short leg 25 mm and top is 25 mm across. After |
| | | | the presentation of each trial, three thicker equal-length |
| | | | lines mask the U-shape for 500 ms to control for effective |
| | | | processing duration of the stimuli. Next cue is not |
| | | | presented until participant 102 presses 1 or 2 to indicate |
| | | | which was longer, the right or left side. 5 trials presented |
| | | | for each duration of the target (i.e., 6, 12, 19, 25, 31, 37, |
| | | | 44, 50, 62, 75, 87, 100, 125, 150, and 200 ms). Record |
| | | | number correct and the number incorrect. Sample score |
| | | | is correct minus incorrect or correct/incorrect, for |
| | | | example. |
| 3 | 1 | Paired- | Practice: pictures paired with numbers for 15 seconds |
| | | Associative | (studying) and then removed. Subsequently, pictures |
| | | Learning | alone are displayed. Participant 102 enters (e.g., types in) |
| | | (Picture/Number) | the corresponding number that goes with each picture. |
| | | | Corrective feedback given. Test: additional pictures |
| | | | paired with numbers for 3 seconds each (for 15 pairs), |
| | | | then 1 minute to enter the numbers that go with each |
| | | | picture (when shown pictures only). Three trials. Record |
| | | | number correct and incorrect. In another implementation, |
| | | | the test is run for one trial. Alternatively or in |
| | | | combination, the numbers and the pictures are shown in a |
| | | | random fashion and the participant 102 matches the |
| | | | numbers to their corresponding pictures. In certain |
| | | | embodiments, a set of images are shown and the |
| | | | participant 102 is instructed to select the pictures within |
| | | | the set of images that the participant 102 previously saw |
| | | | paired with numbers. Correct and incorrect responses are |
| | | | recorded. |
| 3 | 2 | Paired- | Practice: words paired with numbers for 1 minute (studying) |
| | | Associative | and then words alone. participant 102 s must enter the |
| | | Learning | number that goes with each word. Corrective feedback given. |
| | | (Word/Number) | Test: additional words paired with numbers for 3 minutes, |
| | | | then 2 minutes to enter the numbers that go with each word |
| | | | (when shown words only). Record number correct, incorrect, |
| | | | and time (e.g., if less than 2 min). |
| 4 | 1 | Number | Practice: Two numbers presented side-by-side (separate |
| | | Matching | columns) with multiple rows below. Participant 102 |
| | | | must indicate whether the two numbers are the same or |
| | | | not. Corrective feedback given. Maximum of 60 |
| | | | seconds for practice problems, or answers are given. |
| | | | Test: additional numbers presented in the same manner, |
| | | | with participant 102 s responding in the same way for 2 |
| | | | minutes. Record number correct, incorrect, and time |
| | | | (e.g., if less than 2 min). |

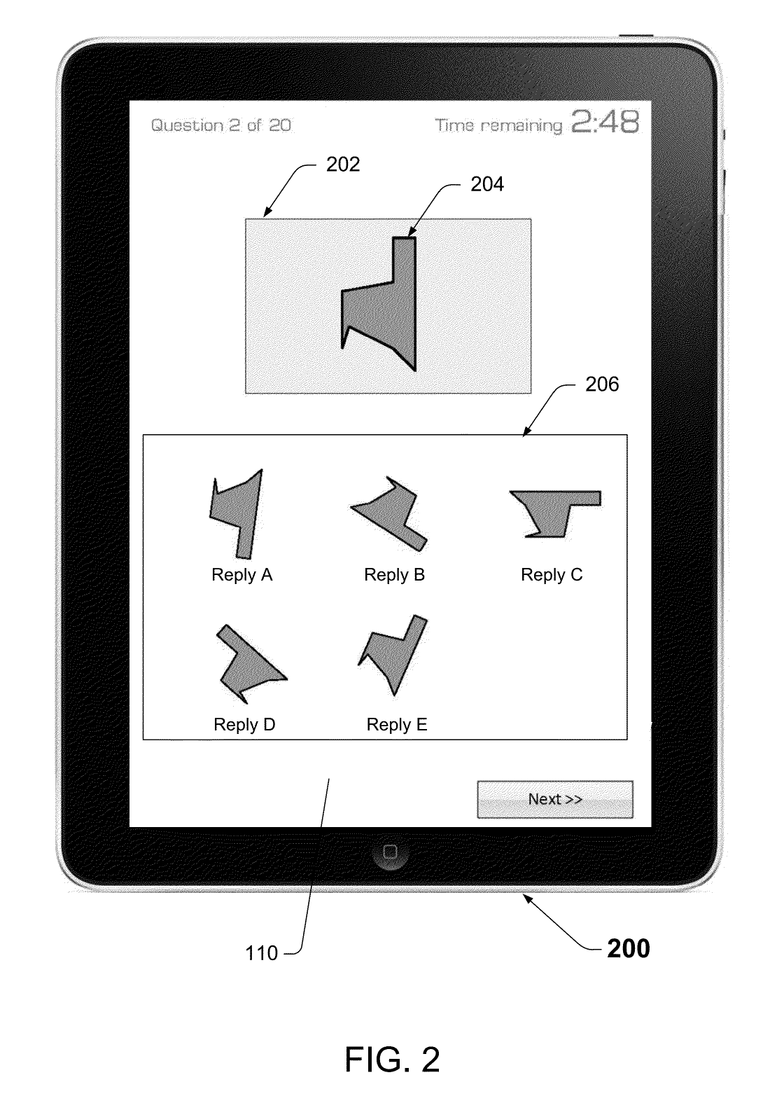

To illustrate, and referring to FIG. 2, an exemplary question 202 of exam 110 tests a visual processing innate cognitive aptitude of the participant 102. The exam 110 includes exemplary question 202 and potential replies 206 rendered on a computing device 200. Here, question 202 instructs the participant 102 to select, within a predetermined amount of time, from among the potential replies 206 one or more shapes that require at least a flipped reflection of image 204. Here, question 202 of exam 110 measures the participant's 102 visual processing by testing the participant's 102 ability to perceive, synthesize, analyze, and think with visual patterns, including the ability to store and recall visual representations. A correct answer to exemplary question 202 is Reply A and/or Reply C. Consequently, if the participant 102 selects either Reply A or Reply C, for example, the participant 102 receives one “point” towards the participant's 102 visual processing innate cognitive aptitude score. In this example, the other innate cognitive aptitude abilities of the participant 102 are evaluated by other questions.

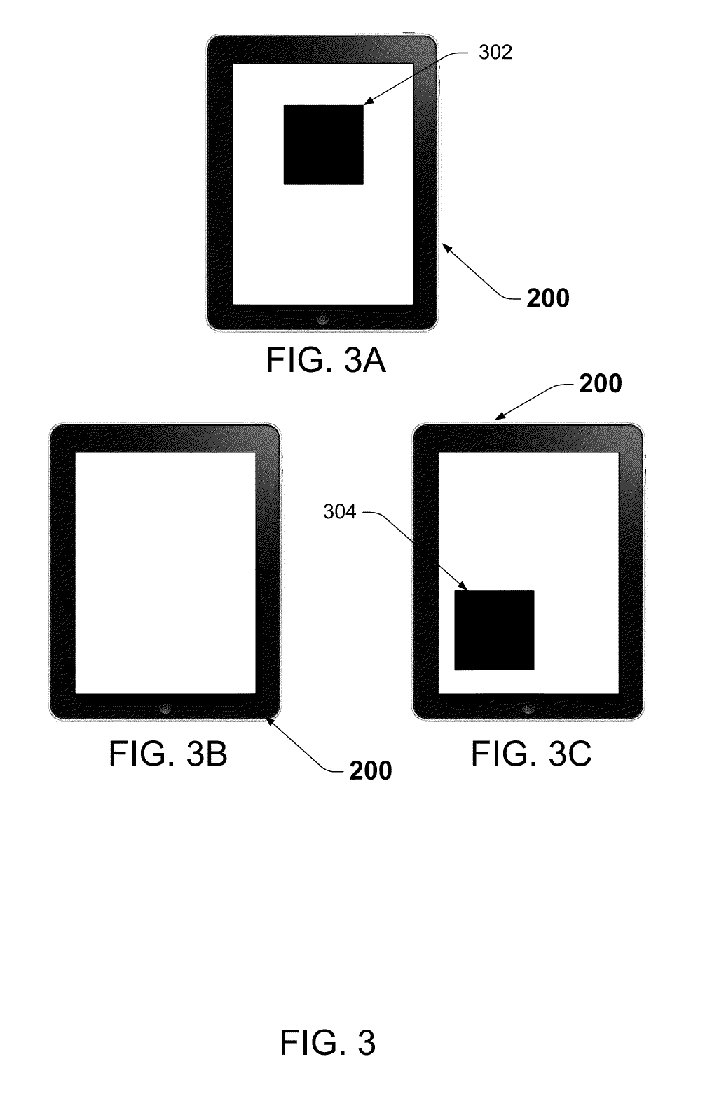

To illustrate further, and referring to FIGS. 3A-3C, an exemplary question 302 tests the reaction time innate cognitive aptitude of the participant 102. Here, an image 302 is initially rendered on a touch screen of the computing device 200. The participant 102 is notified that the image will soon disappear (FIG. 3B) and instructed to tap the touch screen of the computing device 200 as soon as the image 304 appears (FIG. 3C) on the touch screen. In certain embodiments, the participant 102 is instructed to tap the touch screen at the location where the image 304 appears. The sequence of disappearing (FIG. 3B) and appearing images (FIG. 3C) continues, according to a predetermined sequence, for a predetermined time period. Here, question 302 of exam 110 measures the participant's 102 reaction time by testing the participant's 102 ability to immediacy react to stimuli or a task. In certain embodiments, question 302 further determines if is able to accurately locate the appearing image on the touch screen.

In certain embodiments, the number or correct replies, erroneous replies, and time lapse to respond is tracked and used to assess the innate cognitive aptitude of the participant 102. To illustrate, in the above example, correct replies include the participant's 102 tap on the touch screen when the image 304 is displaying. Erroneous replies include the participant's 102 commissions and or omissions. A commission occurs when the participant 102 responds (e.g., taps the screen) when the image 304 is not displayed (e.g., FIG. 3B). An omission occurs when the participant 102 does not respond (e.g., tap the screen) when the image 304 is displayed (e.g., FIG. 3A). The time lapse to respond includes the time between when the image 304 was rendered on the touch screen and when the participant 102 tapped the touch screen in response to the rendition of the image 304 on the touch screen.

In certain embodiments, one or more questions of the exam 110 measure more than one innate cognitive aptitude at a time (“mixed measure” assessment). Here, the participant 102 receives points for answering one or more questions of the exam based on a business rule that allocates the corresponding points based on a degree to which the question tests the corresponding innate cognitive abilities. For example, referring back to FIG. 2, when scoring the participant's response to question 204 of FIG. 2, the participant 102 receives “points” for selecting either or both Reply A and Reply C. Here, the “correct” responses of the participant 102 is weighted, for illustrated purposes only, as follows: 3 visual processing points; 1 processing speed point; 0 long-term storage & retrieval points; and 0 reaction time points while an incorrect response would get the participant no points or, in some embodiments, negative points. Other business rules for allocating points are also contemplated.

For example, an exemplary question of the exam 110 renders an image of a first map for a predetermined amount of time and instructs the participant 102 to memorize the first map in order to pick out the first map in a subsequent rendition of potential replies 116 including respective maps. The image of the first map is then not rendered and the plurality of potential replies including corresponding maps is displayed. In this example, the exemplary question measures both the participant's 102 Short Term Memory and Visual-Processing cognitive aptitude in one question because the participant 102 uses his ability to apprehend and hold information in immediate memory and then use it within a few seconds and his ability to perceive, synthesize, analyze, and think with visual patterns to provide the response to the question. Consequently, for illustrative purposes only, when scoring the participant's response to the exemplary question, the participant 102 receives “points” as follows: 2 Visual Processing points; 1 Processing Speed point. Other business rules and scoring schemes are also contemplated.

Alternatively, or in combination, the exam 110 has no correct answer and the participant 102 makes a judgment call when responding. To illustrate, and referring back to the example of FIG. 2, if question 202 instructs the participant 102 to select from among the potential replies 206 a reply that would require the least amount of manipulation of image 204. Here, there is no “correct” answer. Each potential reply is allocated a series of points for each innate cognitive aptitude based on a business rule. The table below illustrates exemplary point allocations, based on an exemplary business rule, for the potential replies 206 of FIG. 2:

TABLE 2

| | | | Long-Term | |
|---|---|---|---|---|
| | Visual | Processing | Storage & | Reaction |
| | Processing | Speed | Retrieval | Time |
| Reply A | 0 | 0 | 1 | 1 |
| Reply B | 1 | 1 | 2 | 1 |
| Reply C | 0 | 0 | 3 | 1 |
| Reply D | 2 | 1 | 2 | 1 |
| Reply E | 3 | 1 | 3 | 1 |

Here, if the participant 102 selected Reply A, the participant 102 would only receive 1 Long-Term Storage & Retrieval and 1 Reaction Time points while if the participant 102 selected Reply E, the participant would receive 3 Visual Processing; 1 Processing Speed; 3 Long-Term Storage & Retrieval; and 1 Reaction Time points.

In certain embodiments, a plurality of the responses of the participant 102 (e.g., all or a portion of the response) to the questions in the exam 110 evaluated to determine an overall profile of the participant 102. In certain embodiments, outliers in the responses of the participant 102 are not used when determining the overall profile of the participant 102. For example, the exam 110 has 50 questions to which the participant 102 responds. The corresponding responses of the participant 102 is measured as described above, such as based on a business rule, resulting in a cognitive aptitude profile as follows: 130 visual processing; 127 reaction time; 129 long-term storage & retrieval; and 150 processing speed, for example.

In certain embodiments, the cognitive aptitude profile of the participant 102 is compared with one or more known cognitive aptitude profiles (e.g., for a sport and or position within a sport) to find a match. For example, the cognitive aptitude profile of the participant 102 is compared with a known cognitive aptitude profile of a: football/linebacker; football/safety; track/100 meter dash runner; or other sport/position. For illustrative purposes only, exemplary corresponding known cognitive profiles are denoted in Table 3 below:

TABLE 3

| | Football/ | Football/ | Track/100M |
|---|---|---|---|
| | Linebacker | Safety | Dash Runner |
| Visual- | 140 | 110 | 70 |
| Processing | | | |
| Long- | 130 | 90 | 100 |
| Term | | | |
| Storage & | | | |
| Retrieval | | | |
| Reaction | 140 | 130 | 160 |
| Time | | | |
| Processing | 160 | 110 | 170 |
| Speed | | | |

Although Table 3 illustrate four known cognitive aptitude profiles, the participant's 102 profile can be compared to any number of known cognitive aptitude profiles.

In certain embodiments, known cognitive aptitude profiles are developed by administering the exam 110 to one or more professional athletes, who's responses, or arithmetic combination thereof, are used as the standard for the corresponding cognitive aptitude profile sport/position. Alternatively, or in combination, the known cognitive aptitude profiles are developed by administering the exam 110 to one or more peers of the participant 102. The responses from the peers are then statistically analyzed to develop a classification within the group. To illustrate, one such statistical analysis determines that the top 95 percentile of the participant's 102 peers in the sport of football have a profile that is close to: 140 Visual Processing; 140 Reaction Time; 130 Long-Term Storage & Retrieval; and 160 Processing Speed.

Referring back to the above example, a comparison of the participant's 102 profile of: 130 Visual Processing; 127 Reaction Time; 129 Long-Term Storage & Retrieval; and 150 Processing Speed with Table 3 indicate that the participant's 102 profile closely (e.g., statistically close) matches that of the known cognitive aptitude profile of a football linebacker. Here, the degree to which the two profiles match can be further measured on a scale to denote a category for the participant 102. For example, if the profile of the participant 102 matches the known cognitive aptitude profile of a football linebacker in a statistically close manner, then the participant 102 is categorized as “advanced” while a participant's 102 profile that is statistically different from the known cognitive aptitude profile of a football linebacker would be categorized as “deficient.” In the above example, the profile of the participant 102 is close to the known cognitive aptitude profile for a football player and thus, the participant is categorized as having an advanced level of cognitive aptitude for football. Consequently, this comparison categorizes the participant 102 as well suited for the sport of football, and further categorizes the participant 102 as likely an excellent candidate for a linebacker position, for example. In certain embodiments, the decision makers, such as scouts at an NFL scouting combine, use the reported category of the participant 102 in the decision maker's pre-draft assessment. The pre-draft assessment includes, for example, determining a draft status, salary, and/or position of the participant 102.

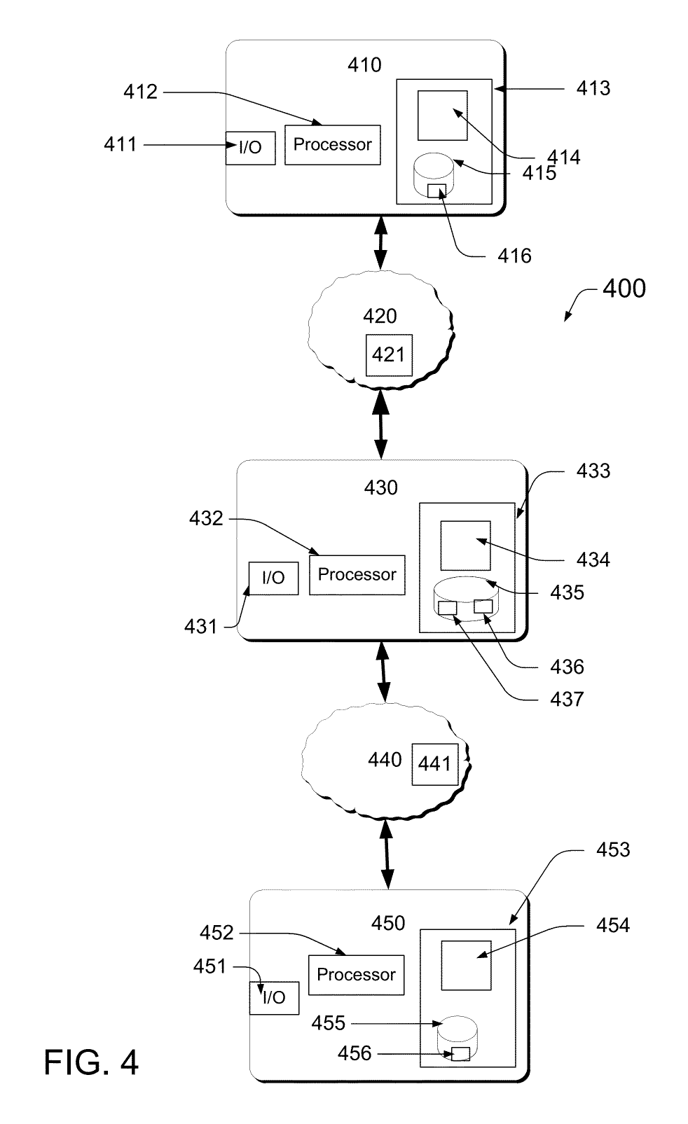

Referring to FIG. 4, a system 400 for innate cognitive aptitude assessment is illustrated. In the illustrated embodiment of FIG. 4, system 400 comprises a computing device 430 that is communicatively connected to a computing device 410 through a first communication fabric 420 and a computing device 450 through a second communication fabric 440. In certain embodiments, the computing device 430 represents one or more computing devices that are owned and/or operated by a host; the computing device 450 represents one or more computing devices that are owned and/or operated by a participant (e.g., participant 102); and the computing device 410 represents one or more computing devices that are owned and/or operated by a decision maker, such as a coach, agent, or recruiter.

In certain embodiments, the computing device 430 is also the computing devices 410 and 450. Here, a single computing device 430 is owned and/or operated by each of the host, the participant, and the decision maker and the communication fabrics 420 and 440 are not utilized.

For the sake of clarity, FIG. 4 shows a single computing device 410, computing device 430, and computing device 450. FIG. 4 should not be taken as limiting. Rather, in other embodiments any number of entities and corresponding devices can be part of the system 400, and further, although FIG. 4 shows two communication fabrics 420 and 440, in other embodiments less or more than two communication fabrics is provided in the system 400. For example, in certain embodiments, the communication fabric 420 and the communication fabric 440 are the same communication fabric.

In certain embodiments, the computing devices 410, 430, and 450 are each an article of manufacture. Examples of the article of manufacture include: a server, a mainframe computer, a mobile telephone, a personal digital assistant, a personal computer, a laptop, a set-top box, an MP3 player, an email enabled device, a tablet computer, or a web enabled device having one or more processors (e.g., a Central Processing Unit, a Graphical Processing Unit, programmable processor, and/or a microprocessor) that is configured to execute an algorithm (e.g., a computer readable program or software) to receive data, transmit data, store data, or performing methods or other special purpose computer, for example.

By way of illustration and not limitation, FIG. 4 illustrates the computing device 410, the computing device 430, and the computing device 450 as each including: a processor (412, 432, and 452, respectively); a non-transitory computer readable medium (413, 433, and 453, respectively) having a series of instructions, such as computer readable program steps encoded therein; an input/output means (411, 431, and 451, respectively) such as a keyboard, a mouse, a stylus, touch screen, a camera, a scanner, or a printer. The non-transitory computer readable mediums 413, 433, and 453 each include corresponding computer readable program codes (414, 434, and 454, respectively) and data repositories (415, 435, and 455, respectively). The processors 412, 432, and 452 access corresponding computer readable program codes (414, 434, and 454, respectively), encoded on the corresponding non-transitory computer readable mediums (413, 433, and 453, respectively), and executes one or more corresponding instructions (416, 436, and 456, respectively). In certain embodiments, the non-transitory computer readable mediums 413, 433, and 453, each comprises one or more hard disk drives, tape cartridge libraries, optical disks, and combinations thereof.

In one example, the processors 412 and 452 access corresponding Application Program Interfaces (APIs) encoded on the corresponding non-transitory computer readable mediums (413 and 453, respectively), and executes instructions (e.g., 416 and 456, for example respectively) to electronically communicate with the computing device 430. Similarly, the processor 432 accesses the computer readable program code 434, encoded on the non-transitory computer readable medium 433, and executes an instruction 436 to electronically communicate with the computing device 410 via the communication fabric 420 or electronically communicate with the computing device 450 via the communication fabric 440.

In certain embodiments the data stored in the data repository 435 of the host computing device 430 includes information received from the computing device 450 of the participant or the computing device 410 of the decision maker, or their respective past usage of the system 400. A log 437 is maintained of the information or data about the communicated information (e.g., date and time of transmission, frequency of transmission . . . etc.) with the computing device 430 and/or the computing device 450. In certain embodiments, Applicants' method reviews, analyzes, or mines log 437 and generates reports based upon prior usages of the system 400.

In certain embodiments, the data repositories 415, 435, and 455 each comprises any suitable data storage medium, storing one or more databases, or the components thereof, in a single location or in multiple locations, or as an array such as a Direct Access Storage Device (DASD), redundant array of independent disks (RAID), virtualization device, . . . etc. In certain embodiments, one or more of the data repositories 415, 435, and 455 is structured by a database model, such as a relational model, a hierarchical model, a network model, an entity-relationship model, an object-oriented model, or a combination thereof. For example, in certain embodiments, the data repository 435 is structured in a relational model and stores a plurality of questions or corresponding potential replies as attributes in a matrix for an identified innate cognitive aptitude.

In certain embodiments, the computing devices 410, 430, and 450 include wired and/or wireless communication devices which employ various communication protocols including near field (e.g., “Blue Tooth”) and/or far field communication capabilities (e.g., satellite communication or communication to cell sites of a cellular network) that support any number of services such as: Short Message Service (SMS) for text messaging, Multimedia Messaging Service (MMS) for transfer of photographs and videos, electronic mail (email) access, or Global Positioning System (GPS) service, for example. In certain embodiments, the computing device 410, 430, and 450 employ hardware and/or software that supports timers, accelerometers, gyroscopes, solid state compasses and the like.

As illustrated in FIG. 4, the communication fabrics 420 and 440 each comprise one or more switches 421 and 441, respectively. In certain embodiments, at least one of the communication fabrics 420 and 440 comprises the Internet, an intranet, an extranet, a storage area network (SAN), a wide area network (WAN), a local area network (LAN), a virtual private network, a satellite communications network an interactive television network, or any combination of the foregoing. In certain embodiments, at least one of the communication fabrics 420 and 440 contains either or both wired or wireless connections for the transmission of signals including electrical connections, magnetic connections, or a combination thereof. Examples of these types of connections include: radio frequency connections, optical connections, telephone links, a Digital Subscriber Line, or a cable link. Moreover, communication fabrics 420 and 440 utilize any of a variety of communication protocols, such as Transmission Control Protocol/Internet Protocol (TCP/IP), for example.

In certain embodiments, one or more portions of the system 400 is implemented as a software and/or hardware module that is locally and/or remotely executed on one or more of the computing devices 410, 430, and 450. For example, one or more portions of the system 400 includes a hardware-based module (e.g., a digital signal processor (DSP), a field programmable gate array (FPGA)) and/or a software-based module (e.g., a module of computer code or a set of processor-readable instructions that can be executed at a processor). In certain embodiments, such modules are be implemented as a hardware circuit comprising custom VLSI circuits or gate arrays, off-the-shelf semiconductors such as logic chips, transistors, or other discrete components. For example, a module is implemented in programmable hardware devices such as field programmable gate arrays, programmable array logic, programmable logic devices, or the like. Alternatively, or in combination, one or more modules are implemented in software for execution by various types of processors. An identified module of executable code, for instance, comprises one or more physical or logical blocks of computer instructions that, for instance, organized as an object, procedure, or function. Nevertheless, the executables of an identified module need not be physically collocated, but are comprise, in certain embodiments, disparate instructions stored in different locations which, when joined logically together, comprise the module and achieve the stated purpose for the module.

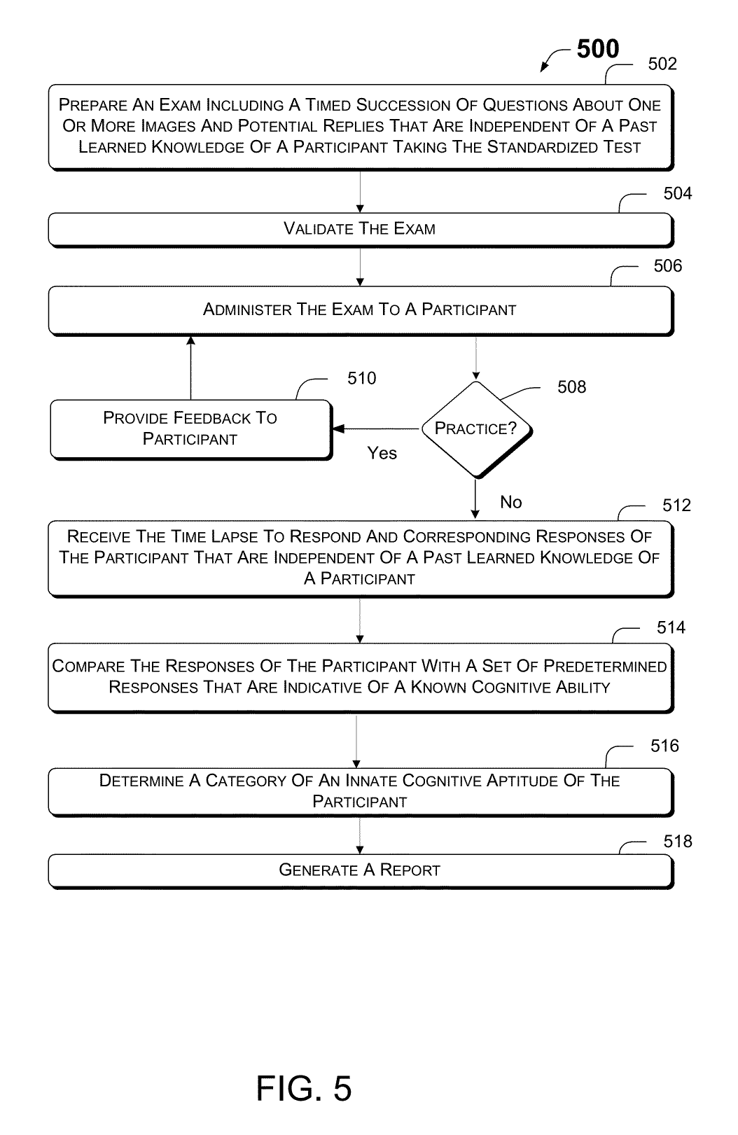

Referring to FIG. 5, a flow chart illustrates and exemplary method 500 for assessing one or more innate cognitive aptitudes of a participant 102 (e.g., participant 102). At a step 502, an exam (e.g., exam 110) is prepared and encoded in a non-transitory medium of one or more of the computing devices of system 400, such as at the non-transitory medium 433 of the host computing device 430. The exam includes a timed succession of questions about one or more images and one or more corresponding potential replies. As stated previously, the potential replies, and corresponding responses of the participant selected from the potential replies, are independent of the past knowledge of the participant, such as being independent of a reading comprehension and/or writing ability of the participant.

In certain embodiments, the business rules for associating innate cognitive aptitudes to the questions and/or replies are determined. For example, one or more business rules are determined to allocate a numerical value associated with one or more innate cognitive abilities to the questions and/or replies of the exam questions and/or replies. In certain embodiments, the corresponding value is encoded in the non-transitory readable medium.

At step 504 of method 500, the exam is validated. For example, the exam is administered to a second, different participant with a known high cognitive aptitude (e.g., a well performing professional athlete). If the professional athlete's responses score low on the exam, the questions and/or corresponding potential replies are modified and steps 502 and 504 are repeated.

At step 506, the exam is administered to the participant, such as participant 102. For example, the computing device 450 of the participant 102 accesses the exam 110 stored at the host computing device 430 via the communication fabric 440 and renders the exam on the computing device 450 for a timed, interactive session with the participant. Alternatively, or in combination, the computing device 450 of the participant 102 accesses the exam encoded on the non-transitory readable medium 453 of the computing device 450 and executes code to administer the exam 110 by rendering it on the computing device 450 of the participant 102 for the interactive session. Here, the recorded reaction time of the participant 102 is independent of the transmission speed between computing devices of system 400 of FIG. 4, for example.

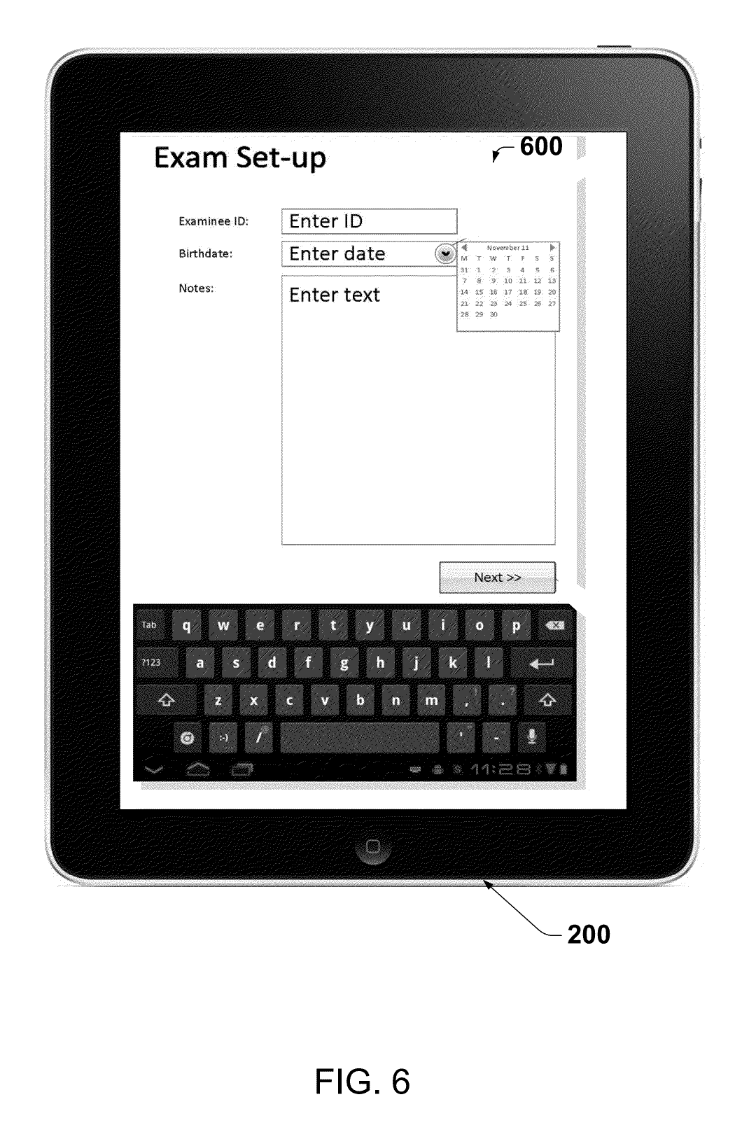

To illustrate and referring to FIG. 6, a screen shot of a user interface 600 rendered on the display of the computing device 450 of the participant is illustrated. Here, the participant enters information about the participant, which is in turn, encoded (e.g., at the data repository 433 and/or 453) in association with the subsequent responses of the participant 102.

As stated previously, the exam is timed and the participant has a limited reply time for each successive question rendered on the display of the computing device 450 of the participant. For example, a first question displays, for a predetermined amount of time (e.g., 1 minute) a first image, instructing the participant to study the image and match subsequently displayed potential replies. After the lapse of the predetermined amount of time, one or more second images are displayed for a second predetermined amount of time during which the participant responds (e.g., the limited reply time). The participant 102 then selects the second images that correspond with the first and the responses of the participant 102, along with corresponding reaction times are stored at the computing device administering the exam and/or transmitted to a second computing device in the system of FIG. 4.

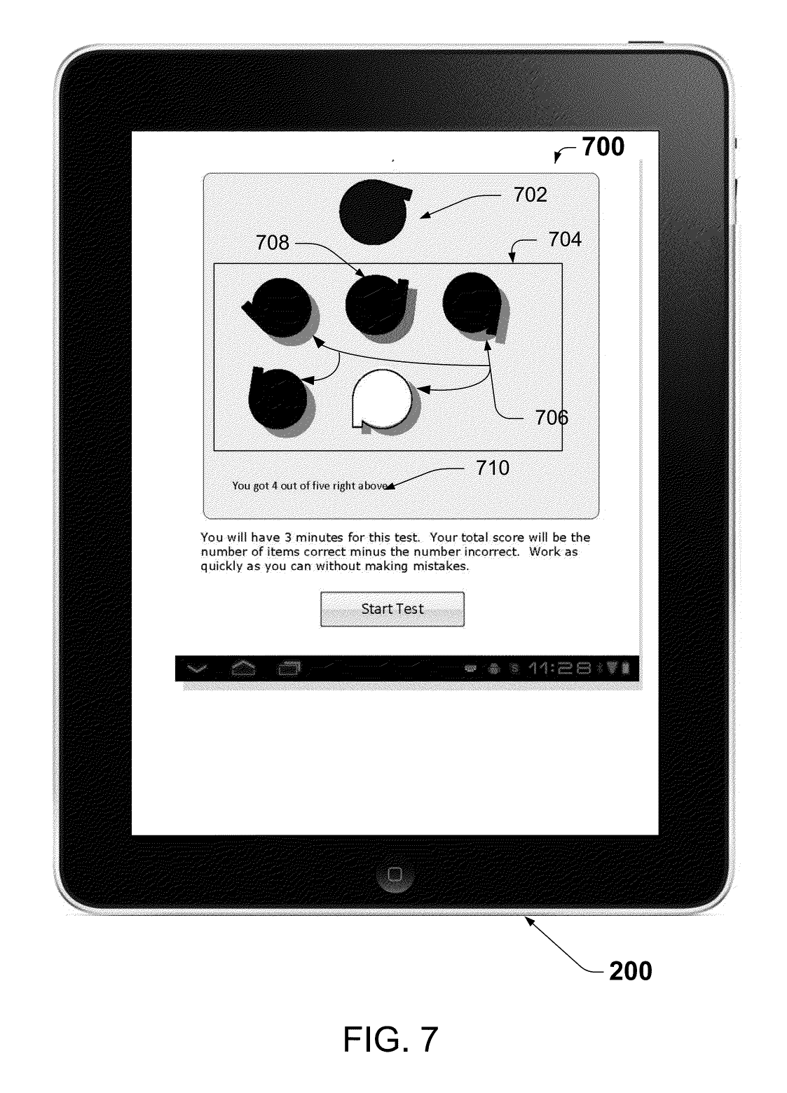

Referring back to method 500 of FIG. 5 and FIG. 7, at step 508 a determination is made if the participant 102 is conducting a practice session. At FIG. 7, a screen shot of a user interface 700 illustrates and exemplary question and corresponding potential replies. Here, the participant is instructed to look at image 702 and determine, within three minutes, which of the shapes in the potential replies 704 is a rotated manipulation of the image 702. If the display is a touch screen, the participant is further instructed to select a response from among the potential replies 704 by touching the screen. Here, a score for the practice takes into consideration the number of the participant's correct responses minus the number of incorrect responses. As denoted in FIG. 5, if the question is a practice question, the method 500 moves to step 510, at which feedback is provided to the participant. For example, the score 710, the correct response 706, and the incorrect response 708 is rendered on the display of the computing device 450. In certain embodiments, feedback is provided to the participant for non-practice questions.

If the questions for the administered standard test 110 are not practice questions, the method 500 moves from step 508 to step 512. At step 512, the responses of the participant and/or the time lapse to respond between at least one question and a corresponding response of the participant are received. For example, the host computing device 430 of FIG. 4 receives a transmission from the participant's computing device 450 including the responses and time lapse to respond of the participant. As stated previously, the responses are independent of the past learned knowledge of the participant.

At step 514, the responses of the participant are compared with a set of predetermined responses that are indicative of a known cognitive aptitude. For example, the responses of the participant are directly compared with the response to the exam of a professional athlete having a known stellar performance during the execution of a sport. Alternatively, or in combination, as previously described, the responses of the participant are scored using innate cognitive aptitudes to determine a profile, e.g. for the participant. The profile of the participant is then compared to a known cognitive aptitude profile, such as the known cognitive profile for a professional linebacker and illustrated in Table 3.

At step 516 of method 500, one or more categories of an innate cognitive aptitude of the participant is determined based on the comparison in step 514. For example, as stated previously, the innate cognitive aptitude of participant 102 is identified as: “advanced” or as a “valuable candidate for a linebacker position” based on the comparison of the participant's profile with the known cognitive aptitude profile 140.

At step 518, a report is generated. For example, the computing device 430 forms a transmission addressed to the computing device 410 of the decision maker including, for example, the determined category of step 516, the value of the respective innate cognitive aptitude measured, omissions, and/or commissions of the participant. The decision maker, in turn, uses the reported to determine to determine recruitment, career path, and/or training of the participant 102. To illustrate, a coach decision maker receives the report, which shows that the participant is deficient in a long-term storage and retrieval innate cognitive aptitude. Here, the coach refines the training for the participant 102 to take advantage of the participant's 102 other skills to compensate for the deficiency in long-term storage and retrieval. For example, the coach uses pneumatics to help teach the participant 102 a play. In another example, the report indicates that the participant 102 has a high number of commissions (e.g., false starts) and is therefore deficient in his reaction time innate cognitive aptitude. Here, the coach would augment the training of the participant 102 to use his peripheral vision to observe his teammates start times.

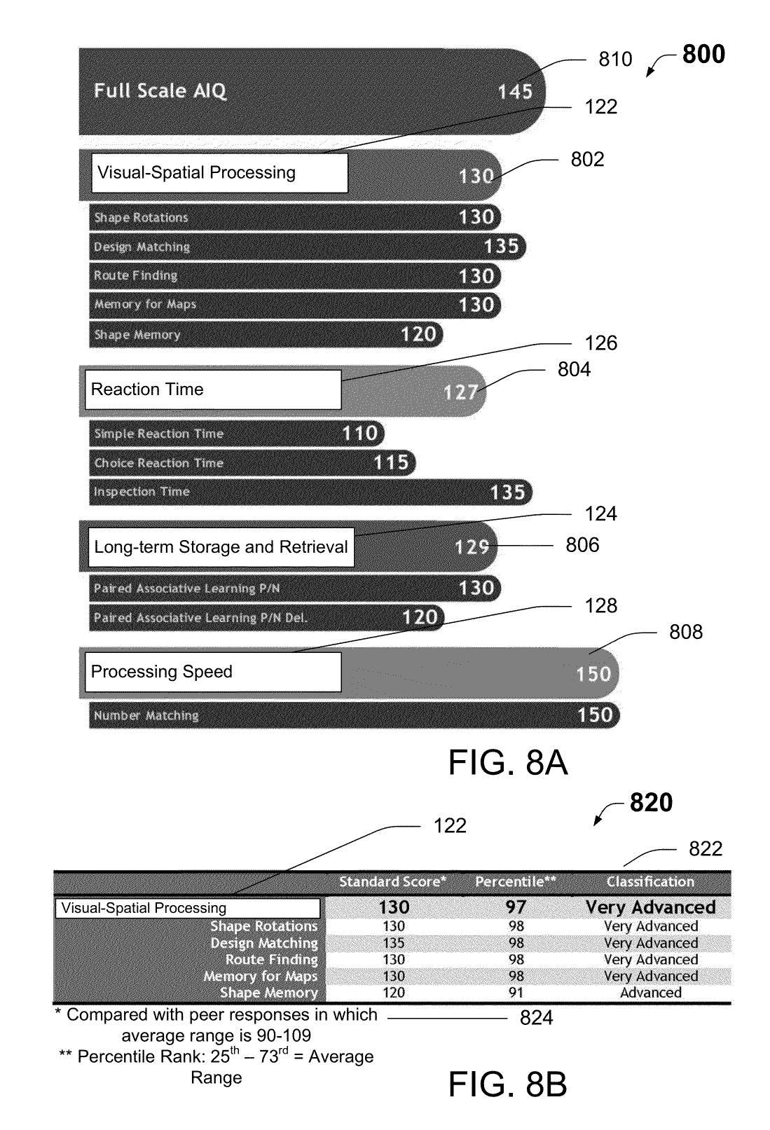

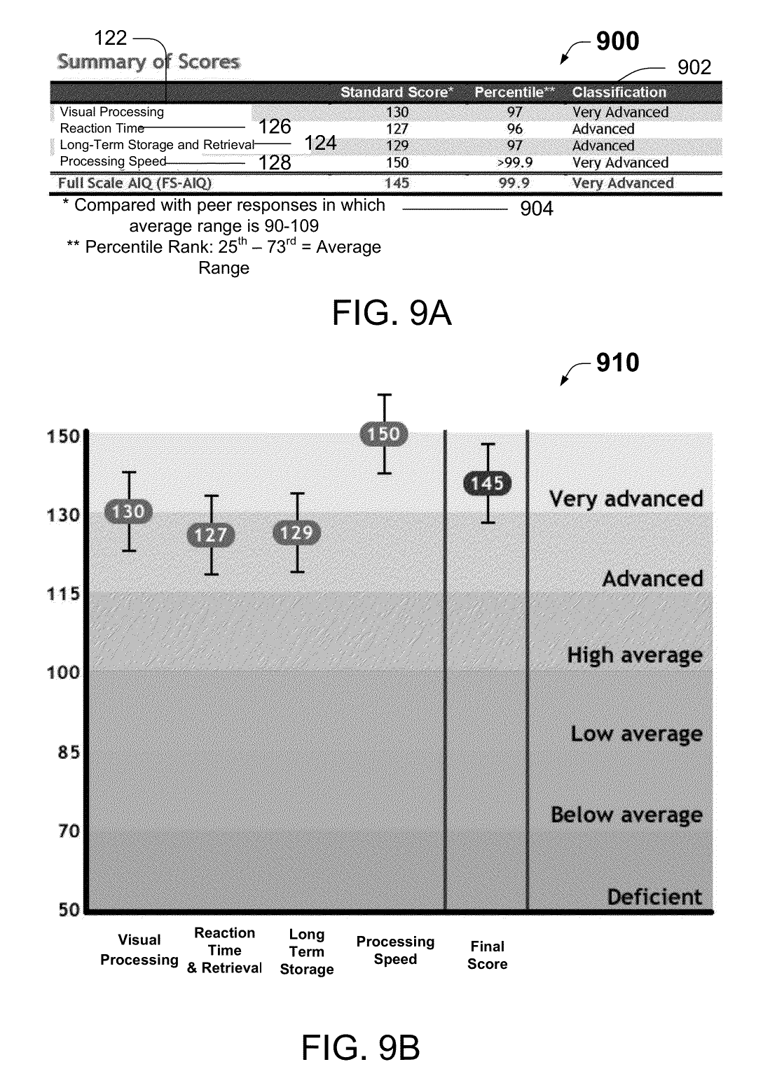

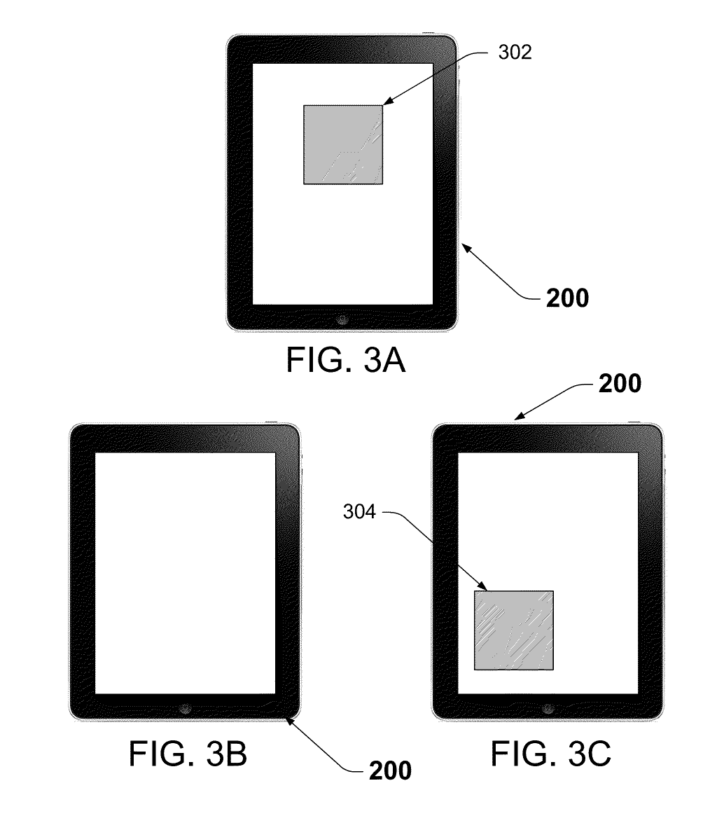

Referring to FIGS. 8A, 8B, 9A, and 9B, portions of an exemplary report is illustrated. Here, the value for each a first portion 800 of the exemplary report includes an overall score 810 and the profile including the values (802, 804, 806, and 808, respectively) for the innate cognitive aptitudes: Visual-Spatial processing 122; Reaction Time 126; Long-Term Storage & Retrieval 124 ; and processing speed 128. Moreover, FIG. 8B illustrates a classification (e.g., category) for the Visual-Spatial Processing 122 innate cognitive aptitude. The portion 820 of the exemplary report illustrated in FIG. 8B, further indicates the category 822 of the participant based on the comparison of the profile of the participant 102 to a known cognitive profile. Here, the known cognitive profile is based on responses to the exam of peers of the participant 824. Similarly, the portion 900 of the report illustrated in FIG. 9A includes the values for the innate cognitive aptitudes and the category 902 of the participant based on the comparison of the profile of the participant to the known cognitive profile based on a set of predetermined responses 904. In FIG. 9B, the data of FIG. 9A is displayed graphically on the computing device of system 400 of FIG. 4, such as the computing device 410 of the decision maker. The decision maker, in turn, determines whether to recruit the participant or devise a practice plan for the participant based on the report rendered in the user interfaces 800, 810, 900, and 910, for example.

In certain embodiments, the category and/or value for the value of the respective innate cognitive aptitude measured is stored at a data repository and compared with corresponding category and values determined for a subsequent administration of the exam to the participant.

The schematic flow chart diagrams included are generally set forth as a logical flow-chart diagram (e.g., FIG. 5). As such, the depicted order and labeled steps are indicative of one embodiment of the presented method. In certain embodiments, other steps and methods are conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types are employed in the flow-chart diagrams, they are understood not to limit the scope of the corresponding method (e.g., FIG. 5). Indeed, some arrows or other connectors may be used to indicate only the logical flow of the method. For instance, an arrow indicates a waiting or monitoring period of unspecified duration between enumerated steps of the depicted method. Additionally, the order in which a particular method occurs may or may not strictly adhere to the order of the corresponding steps shown.

In certain embodiments, individual steps recited in FIG. 5 are combined, eliminated, or reordered. In certain embodiments, the computer readable program code described reside in any other computer program product, where that computer readable program code is executed by a computer external to, or internal to, system 400 (FIG. 4), to perform one or more of steps recited in FIG. 5. In either case, in certain embodiments, the computer readable program code is encoded in a non-transitory computer readable medium comprising, for example, a magnetic information storage medium, an optical information storage medium, an electronic information storage medium, and the like. “Electronic storage media,” means, for example and without limitation, one or more devices, such as and without limitation, a PROM, EPROM, EEPROM, Flash PROM, compactflash, smartmedia, and the like.

Examples of computer readable program code include, but are not limited to, micro-code or micro-instructions, machine instructions, such as produced by a compiler, code used to produce a web service, and files containing higher-level instructions that are executed by a computer using an interpreter. For example, embodiments are implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, multiple, distributed qualification processing systems can be configured to operate in parallel.

Although the present invention has been described in detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

We claim:

1. A computer program product encoded in a non-transitory computer readable medium, the computer program product being useable with a computing device comprising a display and a programmable processor to assess an innate cognitive aptitude of a participant, the computer program product comprising:
computer readable program code which causes a programmable processor to administer an exam to a participant including rendering, on a display, a timed succession of questions about one or more images and corresponding potential replies, wherein the corresponding potential replies are independent of a reading comprehension and writing ability of the participant;
computer readable program code which causes the programmable processor to receive responses of the participant, each selected from corresponding potential replies;
computer readable program code which causes the programmable processor to compare the responses of the participant to a set of predetermined said responses that are indicative of a known cognitive aptitude to find a result;
computer readable program code which causes the programmable processor to determine a category of an innate cognitive aptitude of the participant based on the result;
and
reporting the category.

2. The computer program product of claim 1, wherein rendering the timed succession of questions further comprises:
rendering, for a first predetermined amount of time, a first said image; and
rendering, for a second predetermined amount of time, the corresponding potential replies, each including a corresponding second image.

3. The computer program product of claim 2, wherein the corresponding second image is selected from the group consisting of: the first image; a rotation of the first image; a mirror reflection of the first image; a change in contrast of the first image; a shadow of the first image; a warped said first image; an augmented said first image; a diminished said first image; and a combination thereof.

4. The computer program product of claim 1, wherein the one or more said images are selected from the group consisting of: a two-dimensional image; a three dimensional image; and a map.

5. The computer program product of claim 1, further comprising computer readable program code which causes the programmable processor to render feedback to the participant regarding the responses of the participant.

6. The computer program product of claim 1, further comprising computer readable program code which causes the programmable processor to form a transmission for delivery to a host computing device, the transmission including at least one of:
the responses of the participant;
data about a time lapse between at least one said question and a corresponding said response of the participant; and
the category.

7. The computer program product of claim 1, further comprising computer readable program code which causes the programmable processor to determine a first value for a first innate cognitive aptitude based on the responses of the participant, wherein comparing the responses of the participant to the set of predetermined said responses includes comparing the first value with a second value for the first innate cognitive aptitude, and wherein the second value is based on the set of predetermined said responses.

8. The computer program product of claim 7, wherein the first innate cognitive aptitude is selected from a group consisting of: a visual processing ability;
an image storage and retrieval ability; a reaction time ability; a processing speed ability; and a combination thereof.

9. The computer program product of claim 7, further comprising determining a plurality of said first values for corresponding said innate cognitive aptitude to determine a first profile for the participant and comparing the first profile with a second profile based on corresponding said second values.

10. An article of manufacture comprising a processor and a non-transitory computer readable medium having computer readable program code disposed therein to assess an innate cognitive aptitude of a participant, the computer readable program code comprising a series of computer readable program steps to effect:
receiving responses of a participant to an exam including one or more questions about a respective first image, wherein:
each said question has a limited corresponding reply time; and
the responses of the participant are independent of a reading comprehension, writing ability, and past learned knowledge of the participant;
comparing the responses of the participant to a set of predetermined said responses that are indicative of a known cognitive aptitude to find a result;
determining a category of an innate cognitive aptitude of the participant based on the result;
and
reporting the category.

11. The article of manufacture of claim 10, wherein the responses include a selection of the participant, within the corresponding limited reply time, of a second image that corresponds to the first image.

12. The article of manufacture of claim 10, wherein the computer readable program code comprising a series of computer readable program steps to further effect receiving data about a time lapse between a first said question and a corresponding said response of the participant.

13. The article of manufacture of claim 10, wherein the computer readable program code comprising a series of computer readable program steps to further effect:
determining a value of the innate cognitive aptitude based on the responses of the participant; and
determining a second value for the innate cognitive aptitude based on the set of predetermined said responses, wherein comparing the responses of the participant to the set of predetermined said responses includes comparing the first value with the second value.

14. The article of manufacture of claim 13, wherein the innate cognitive aptitude is selected from a group consisting of: a visual processing ability; an image storage and retrieval ability; a reaction time ability; a processing speed ability; and a combination thereof.

15. A method for assessing an innate cognitive aptitude of a participant, the method comprising:
receiving responses of a participant to an exam including one or more questions about a respective image, wherein:
each said question has a limited reply time; and
the responses of the participant are independent of a past learned knowledge of the participant;
comparing the responses of the participant to a set of predetermined said responses that are indicative of a known cognitive aptitude to find a result;
determining a category of an innate cognitive aptitude of the participant based on the result;
and
reporting the category.

16. The method of claim 15, wherein the innate cognitive aptitude is selected from a group consisting of: a visual processing ability; an image storage and retrieval ability; a reaction time ability; a processing speed ability; and a combination thereof

17. The method of claim 15, wherein the one or more questions are regarding at least one of: a first image; a rotation of the first image; a mirror reflection of the first image; a change in contrast of the first image; a shadow of the first image; a warped said first image; an augmented said first image; a diminished said first image; and a combination thereof.

18. The method of claim 15, further comprising rendering feedback to the participant regarding the responses of the participant.

19. The method of claim 15, further comprising forming a transmission for delivery to a host computing device, the transmission including at least one of:
the responses of the participant;
data about a time lapse between at least one said question and a corresponding said response of the participant; and
the category.

20. The method of claim 15, further comprising determining a first value for a first innate cognitive aptitude based on the responses of the participant, wherein comparing the responses of the participant to the set of predetermined said responses includes comparing the first value with a second value for the first innate cognitive aptitude, and wherein the second value is based on the set of predetermined said responses.
